(19) United States
(12) Patent Application Publication
(10) Pub. No.: US 2003/0219524 A1
(43) Pub. Date: Nov. 27, 2003

(54) Formulated hollandaise sauce and process for preparation of the same

(76) Inventor: David L. Kroening, New Ulm, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/386,966

(22) Filed: Mar. 11, 2003

Related U.S. Application Data
(63) Continuation of application No. 10/306,629, filed on Nov. 27, 2002.
(60) Provisional application No. 60/382,903, filed on May 22, 2002.
(60) Provisional application No. 60/392,710, filed on Jun. 27, 2002.

(51) Int. Cl. A23L 1/238

(52) U.S. Cl. 426/589

(57) ABSTRACT

The formulated traditional/classical Hollandaise Sauce is generally comprised of a mixture of EMY egg yolk, melted butter, water, and citric acid which is processed by pasteurization and/or homogenization followed by cooling. This formulation and methodology avoids the costly and undesirable repeated creation of a traditional/classical Hollandaise Sauce for use with consumable food articles over a period of time. The Hollandaise Sauce may be refrigerated or frozen for thawing and reheating prior to use with a food product. Stability for the formulated traditional/classical Hollandaise Sauce is obtained by the formation of an emulsion which is transformed into a protein gel through heating. The protein gel in turn is destroyed by cooling to produce a liquefied Hollandaise Sauce which may be packaged, refrigerated, and/or frozen for future use in cooking activities.

### CLAIM TO PRIORITY

The present application is a Continuation-In-Part application for a “Formulated Hollandaise Sauce and Process for Preparation of the Same” claiming priority to U.S. patent application Ser. No. 10/306,629 filed Nov. 27, 2002 which is based upon Provisional U.S. Patent Application No. 60/382,903, filed May 22, 2002, and Provisional U.S. Patent Application No. 60/392,710, filed Jun. 27, 2002, the entire contents of which are incorporated herein by reference in their entireties.

### BACKGROUND OF THE INVENTION

A problem with the Hollandaise Sauces as presently known is the absence of storage and/or useful life for the product necessitating the repeated creation of fresh sauce for use with consumable food items. Generally Hollandaise Sauce has a useful life of at most a few hours and may not be cooled, reheated or frozen for use at a later time due to the breakdown and separation of the components into an oil and water phase. In the event that separation of the oil and water phases occurs then the sauce is required to be discarded.

The creation of traditional Hollandaise Sauce is generally a time consuming and complicated process. Traditionally, Hollandaise Sauce has been made with butter and other ingredients, but in recent years there has been a substantial change in consumer use and acceptance of margarine, light butter, cream, or sour cream as an alternative or supplement ingredient for butter. A review of the more commonly used cookbooks shows that many modern recipes for Hollandaise Sauce call for use of either butter or margarine, light butter, cream, or sour cream, which are also acceptable. In the traditional Hollandaise Sauce egg yolk is the customary emulsifying ingredient. In addition to egg yolk and butter, traditional Hollandaise Sauce has also included acidifying ingredients such as lemon juice or vinegar, and seasoning such as salt and pepper.

The traditional Hollandaise Sauce as known is relatively difficult to make. Initially, egg yolks are separated from egg whites, where salt, flavors such as lemon juice, and capsicums are added to the yolks and dissolved with water. The egg/water mixture is then heated, heating is done over a flame or boiling water bath, to form a ribbon. The water helps keep the yolk from cooking/scrambling as the egg mixture is fiercely whipped to the desired and appropriate thickness. The ribbon is essential for the overall thickness and foam quality of the sauce. A Hollandaise Sauce which is too thin is unacceptable. A Hollandaise Sauce which is too thick is unacceptable due to the likelihood of cooked particles within the sauce. It is relatively difficult to thin a Hollandaise Sauce which has been made and exhibits unacceptable thickness.

In general, butter or margarine is melted and allowed to rest prior to use within the Hollandaise Sauce. The surface foam of the melted butter is skimmed off whereupon the butter solids are removed, creating clarified butter/margarine. Hot/warmed clarified butter is then drizzled into the heated yolk mixture slowly to develop an emulsion. After the emulsion is formed, the oil from the butter is added at a faster rate.

To insure that the yolk is not cooked, the mixture is continuously agitated through the use of a whip. Whipping and heat allow the yolk to foam and expand. The generation of a foam increases the viscosity of the ingredients. If the yolk mixture is not specifically prepared, then either the yolk will over cook causing a graining appearance (cooked egg particles) or if not heated properly the yolk mixture will be too thin or too thick. Once the yolk has reached the proper processing point, clarified butter is added. If the butter has not been previously clarified, the milk solids within the butter will decrease viscosity and sheen.

The heating of the yolk helps develop the foam while whipping the liquid egg mixture. Foaming is critical to Hollandaise Sauce formulation. In general, the butter must be added slowly, drop by drop at first to the heated yolk mixture. Once an emulsion is started the butter may be added at a faster and faster rate. Should the emulsion breakdown due to the addition of butter oil too rapidly, then it is generally easier to discard the “broken sauce” and restart the formulation process with new materials. Generally, a traditional/classical Hollandaise Sauce is held in a protected area of the kitchen usually near a steam table. It is very difficult and risky to reheat Hollandaise Sauce because when heat is applied the sauce may “break” causing water and oil phases. Both reheating and freezing of the known Hollandaise Sauce are detrimental to the emulsion resulting in breakage and separation of the Hollandaise Sauce into a water and oil phase.

In the past the packaging and/or storage of previously made Hollandaise Sauce for purchase and reheating by consumers was not available. In the past, it was not possible to extend the usable life of Hollandaise Sauce under frozen or refrigerated conditions.

One of the factors for consideration in the manufacture and storage of ready to use Hollandaise Sauce is the elimination of growth of microbiological agents such as Salmonella. Generally in the past it has been problematic to restrict, control, or eliminate the growth of undesirable microbiological organisms within packaged food products and particularly food products including eggs as component.

It has not been known or attempted to utilize a formulation process to inhibit the growth of undesirable microbiological agents in Hollandaise Sauce stored for later consumption. It has also not been known to attempt to utilize a formulation process in conjunction with a pasteurization process and/or a homogenization process to extend the usable life and/or to create a shelf life for ready to use Hollandaise Sauce which may be stored under frozen or refrigerated conditions.

Generally in the past a problem has existed with respect to the storage of pre-cooked food items within containers. Frequently the storage of ready to use cooked food items within containers has resulted in the contamination of the food by microbiological agents or organisms. This contamination problem, to a large extent, results from the unintentional incorporation of microbes in a packaged food product. A need therefore exists for aseptic or clean filled packages of liquid food products such as Hollandaise Sauce which are obtained through the use of a sterilization process. In part, this goal may be accomplished by minimization of the head space for the packaged product.

As known, egg yolk contains many beneficial molecules which are valued for functional and biological characteristics. An unprocessed and uncooked egg yolk, in general, comprises water, yolk proteins and egg lipids. The egg yolk lipids comprise neutral lipids, yolk lecithin, sterols, and cholesterol. For many food items it is desirable to use in the cooking or formulation process retort stable egg yolk powder or enzyme modified liquid egg yolk (EMY). Retort stable egg yolk powder may be obtained by the procedures described herein or through the procedures identified within U.S. Pat. Nos. 5,213,968 or 4,034,124 both of which are incorporated herein by reference in their entireties.

The lipid of an egg yolk is comprised mainly of various phospholipids containing phosphatidylcholine or lecithin, and cholesterol. Proteins constitute 15% to 17% of the yolk, including phosvitin, α- and β-lipovitellins and low density lipoproteins in the yolk granule and α-β-, and γ-livetins as well as lipoproteins in the yolk plasma. γ-livetin has been recognized as the IgG-like antibody and is also commonly referred to a yolk immunoglobulin or IgY.

Due to the ready availability of egg yolk, many attempts have been made to isolate phospholipids (lecithin), IgY, and other bioactive or functional compounds. However, it is difficult to recover lipid components without denaturing or inactivating the egg yolk protein components.

In general the yolk of various strains of chicken eggs is 30% to 36% lipid comprising about 65% triglycerides, 28.3% phospholipids and 5.2% cholesterol. The total amount of saturated fatty acid is approximately 40% of the fatty acids. Major unsaturated fatty acids are oleic, linoleic, and linolenic with a small quantity of C₂₀ω6, C₂₂ω6 and C₂₂ω3 polyunsaturated fatty acids.

Omega-3 highly unsaturated fatty acids are of significant commercial interest in that they had been recently recognized as important dietary compounds for preventing arterial sclerosis and coronary heart disease, for alleviating inflammatory conditions and for retarding the growth of tumor cells.

These beneficial effects are a result of both the omega-3 highly unsaturated fatty acids causing competitive inhibition of compounds produced from omega-6 fatty acids and from beneficial compounds produced directly from the omega-3 highly unsaturated fatty acids themselves.

### BRIEF DESCRIPTION OF THE INVENTION

The formulated traditional/classical Hollandaise Sauce of this invention is, in general, formed of (EMY) enzyme treated egg yolk which may be salted, melted butter which may be unsalted, melted margarine, or combinations of butter, margarine or liquid margarine, citric acid, water, and/or natural flavor, which, in various combinations, yield a stable Hollandaise Sauce which may be cooled, packaged, stored, and reheated at a future date for consumption as a portion of a food article.

The formulated traditional/classical Hollandaise Sauce, in general, is formed of (EMY) egg yolks having a percentage weight as a component of the entire product of at least 13%; butter having a percentage weight at least 70% of the total weight of the Hollandaise Sauce; margarine in substitution for butter having a percentage weight of at least 70% of the total weight of the Hollandaise Sauce; citric acid having a percentage weight of at least 0.05% of the total weight of the Hollandaise Sauce; water having a percentage weight of at least 9% of the total weight of the Hollandaise Sauce; and natural flavor having a percentage weight of at least 0.175% of the total weight of the Hollandaise Sauce.

An advantage of the present invention is the provision of a formulated traditional/classical Hollandaise Sauce of relatively simple and inexpensive composition which is also easy to manufacture and use and which is safe for consumption as a portion of a food product following storage and reheating where the product may be used without fear of sickness to persons and/or spoilage of host food products.

Another principal advantage of the present invention is to provide a formulated Hollandaise Sauce having physical and chemical characteristics similar to a standard and/or traditional Hollandaise Sauce.

Still another principal advantage of the present invention is the provision of a formulated Hollandaise Sauce which is sensorially acceptable for consumption as a direct substitute for a standard and/or traditional Hollandaise Sauce product.

Still another principal advantage of the present invention is the provision of a formulated traditional/classical Hollandaise Sauce which is capable of withstanding cooling, freezing and/or re-heating for use in combination with a final desired food product.

Still another advantage of the formulated traditional/classical Hollandaise Sauce is the provision of (EMY) egg yolk in a percentage by weight of at least 13% of the total weight of the Hollandaise Sauce.

Still another principal advantage of the present invention is the provision of a formulated traditional/classical Hollandaise Sauce having melted butter in a percentage weight of at least 62.5% of the total weight of the Hollandaise Sauce.

Still another principal advantage of the present invention is the provision of a formulated traditional/classical Hollandaise Sauce having melted margarine in substitution for butter in a percentage weight of at least 62.5% of the total weight of the Hollandaise Sauce.

Still another principal advantage of the present invention is the provision of a formulated traditional/classical Hollandaise Sauce having citric acid in a percentage weight of at least 0.050% of the total weight of the Hollandaise Sauce.

Still another principal advantage of the present invention is the provision of a formulated traditional/classical Hollandaise Sauce having water in a percentage weight of at least 9% of the total weight of the Hollandaise Sauce.

Still another principal advantage of the present invention is the provision of a formulated traditional/classical Hollandaise Sauce having natural flavor having a percentage weight of at least 0.175% of the total weight of the Hollandaise Sauce.

Still another principal advantage of the present invention is the provision of a formulated traditional/classical Hollandaise Sauce which initially involves the acquisition of (EMY) egg yolk which may be salted.

Still another principal advantage of the present invention is the provision of a formulated traditional/classical Hollandaise Sauce which involves the melting of the butter in a suitable container where the butter is continuously agitated so that the butter solids remain suspended. It should be noted that the butter is not required to be clarified.

Still another principal advantage of the present invention is the provision of a formulated traditional/classical Hollandaise Sauce which involves dissolving of the citric acid in the water.

Still another principal advantage of the present invention is the provision of a formulated traditional/classical Hollandaise Sauce which involves dispersing of the citric acid/water solution with the enzyme modified egg yolk and thoroughly blending.

Still another principal advantage of the present invention is the provision of a formulated traditional/classical Hollandaise Sauce which involves the constant pouring of the melted butter into a whirling enzyme modified egg yolk mixture for continued mixing for a period of time of approximately sixty seconds following the addition of all of the melted butter to ensure proper emulsification.

Still another principal advantage of the present invention is the provision of a formulated traditional/classical Hollandaise Sauce which involves the processing of the enzyme modified egg yolk and butter mixture through a shear pump and then through a heat exchanger for holding the product for a period of time of approximately 25 seconds at a temperature of approximately 175° F. or 79.44° C.

Still another principal advantage of the present invention is the provision of a formulated traditional/classical Hollandaise Sauce which involves the processing of the enzyme modified egg yolk and butter mixture through a heat exchanger for holding the product for a period of time of approximately 25 seconds at a temperature of approximately 175° F. or 79.44° C.

Still another principal advantage of the present invention is the provision of a formulated traditional/classical Hollandaise Sauce which involves the processing of the enzyme modified egg yolk and butter mixture through a homogenizer having a pressure of approximately 1500 psi.

Still another principal advantage of the present invention is the provision of a formulated traditional/classical Hollandaise Sauce which involves the processing of the enzyme modified egg yolk and butter mixture following heating within two holding tubes for further transfer to a plate chiller for cooling to an approximate temperature of 100° F.

Still another principal advantage of the present invention is the provision of a formulated traditional/classical Hollandaise Sauce which involves the processing of the enzyme modified egg yolk and butter mixture following cooling for passage through a shear pump for transfer to a sterile hopper for further packaging which may include a nitrogen gas flush.

Still another principal advantage of the present invention is the provision of a formulated traditional/classical Hollandaise Sauce which involves the processing of the enzyme modified egg yolk and butter mixture following packaging by refrigerating and/or freezing for storage.

Still another principal advantage of the present invention is the provision of a formulated traditional/classical Hollandaise Sauce which involves the processing of the enzyme modified egg yolk and butter mixture following refrigeration and/or freezing by thawing and re-heating for use with a consumable food item.

Still another principal advantage of the present invention is the provision of a formulated traditional/classical Hollandaise Sauce which has the appearance and functional characteristics of known Hollandaise Sauce products especially with respect to taste and cooking properties.

Several examples of formulation of the traditional/classical Hollandaise Sauce are listed in the table below. It should be noted that the available formulation(s) for the Hollandaise Sauce are not limited or restricted to the below identified examples.

| | Example Formulas | | | | |
|---|---|---|---|---|---|
| Ingredient | 1 | 2 | 3 | 4 | 5 |
| (EMY) Yolk | 14.36% | 15.56% | 15.59% | 15.57% | 14.44% |
| Butter | 76.26% | 74.81% | 00.00% | 74.85% | 76.00% |
| Margarine | 00.00% | 00.00% | 74.94% | 00.00% | 0.0% |
| Citric Acid | 0.06% | 0.10% | 0.10% | 0.10% | 0.06% |
| Water | 9.33% | 9.28% | 9.29% | 9.28% | 9.50% |
| Natural | 0.00% | 0.25% | 0.08% | 0.20% | 0.00% |
| Flavor | | | | | |
| | 100.00% | 100.00% | 100.00% | 100.00% | 100.00% |

Still another principle advantage of the present invention is to create a formulated traditional/classical Hollandaise Sauce which may be processed through the use of commercially available equipment and processing techniques.

Still another principle advantage of the present invention the use of USDA and FDA approved ingredients for formulation of a Hollandaise Sauce.

Still another advantage of the present invention is the provision of a formulated traditional/classical Hollandaise Sauce which may be held as frozen, refrigerated, and/or hot for extended periods of time without loss of product integrity to minimize waste.

Still another advantage of the present invention is the provision of a superior formulated traditional/classical Hollandaise Sauce which includes integrity characteristics not found in other food articles within the same product classification.

Still another advantage of the present invention is the provision of a formulated traditional/classical Hollandaise Sauce having enhanced product consistency which is not found in other food articles within the same product classification.

The present process relates to a formulation for a traditional/classical Hollandaise Sauce food product which may be refrigerated and/or frozen for future heating within a microwave, conventional oven, convection oven, griddle, pressureless steamer, or steam table for consumption by an individual.

Still another principle advantage of the present invention is to reduce preparation time, labor and costs for restaurants and other food service providers which utilize Hollandaise Sauce when serving food articles.

Still another principle advantage of the present invention is the provision of a formulation process which improves the quality of a Hollandaise Sauce through the control of formula conditions.

Still another principle advantabe fo the present invention is the provision of a formulation process which if the sauce becomes “broken” may be made “whole” or reformed into a usable sauce by using a high shear mixer or blender.

### BRIEF DESCRIPTION OF THE DRAWINGS

FIG. 1 is a block diagram depicting one embodiment for the formulation and processing of the traditional/classical Hollandaise Sauce according to the invention herein.

FIG. 2 is a block diagram of an alternative embodiment depicting the formulation and process for the traditional/classical Hollandaise Sauce invention herein.

### DETAILED DESCRIPTION OF THE PREFERRED EMBODIMENT

The formulated traditional/classical Hollandaise Sauce in general relates to a formula and process for improving the stability as well as the useful life for a Hollandaise Sauce which may be cooled, frozen and/or reheated for use as a portion of a consumable food product.

The formulated traditional/classical Hollandaise Sauce and process according to the disclosed methodology may be stored for an acceptable period of time, without deterioration due to microbiological, chemical, or enzymatic activity.

As known, the composition, pH, and moisture content of liquid food products containing eggs provide a nearly ideal environment for the growth of microorganisms including but not limited to Clostridium botulinum, Staphylococcus aureus, Staphylococcus spp., Bacillus spores, parabens, yeasts, Bacillus cereus, Bacillus spp., Bacillus stearothermophilius, Lactobacillus ssp., Lactobacillus fructivorans, Lactobacillus brevis, Lactobacillus buchneri, Lactobacillus plantarum, Heterofermentative lactobacilli, molds, Salmonella spp., Salmonella enteritidis, Salmonella typhimurium, Salmonella heidelberg, Rouxii, xerophilic molds, Enterobacteriaceae, Micrococcus spp., Streptococcus spp., Pseudomonas spp., Acinetobacter spp., Listeria, Listeria monocytogenes, Saccharomyces bailii, Saccharomyces cerevisiae, Zygosaccharomyces bailii (yeast), Zygosaccharomyces bisporous, Zygosaccharomyces rouxii, Aspergillus spp., Aspergillus niger, Cladosporium spp., Penicillium roqueforti, Penicillium crustosum. One common method of terminating the existence of undesirable microorganisms within a liquid food product is to expose the product to known pasteurization techniques. Certain liquid products containing eggs are extremely sensitive to heat-induced coagulation.

The primary purpose for pasteurization within the method for manufacture of the formulated traditional/classical Hollandaise Sauce is to produce an emulsion where the emulsion is transformed into a protein gel through heating. The protein gel may then be destroyed by exposure to chilling through the use of a plate chiller or similar device to produce a pourable Hollandaise Sauce which may be re-heated without risk of the separation or breaking into water or oil phases.

The process methodology utilized further functions to sterilize the formulated traditional/classical Hollandaise Sauce through pasteurization and/or homogenization for elimination of specific pathogenic bacteria such as Salmonella, Staphylococcus, Lysteria and other vegetative bacteria.

For extended shelf life for refrigerated foods, Listeria monocytogenes destruction is another key pasteurization performance criteria. It should be noted that pasteurization alone may be insufficient to control bacteria spores which may be one hundred thousand times more heat-resistant than corresponding vegetative cells of the species. The control of bacterial spores may require the reduction of the water activity level for the product to prevent growth.

The liquid egg product of the present invention may be prepared by first shelling hen eggs to obtain a liquid whole egg product. The liquid egg yolk portion of the liquid whole egg may be isolated by conventional separation techniques. The liquid egg yolk portion is then exposed to a process to yield an enzyme modified yolk EMY which may be obtained through the processing techniques described herein or within U.S. Pat. Nos. 5,213,968 and/or 4,034,124 both of which are incorporated herein by reference in their entireties. In general the EMY processing techniques may involve the steps of:

Initially, adjusting the separated egg yolk to 44%±0.5% dry solids which are then heated or cooled to between 13.5 to 15° C.(56.3 to 59° F.). The pH for the egg yolk material is checked and adjusted to be greater than 6.3 through the addition of a 10% solution of sodium bicarbonate as required;

Next, the pH adjusted egg yolk material is slowly agitated whereupon porcine pancreatic phospholipase A2 is added to obtain approximately 68 milliliters of enzyme preparation having an activity of 10,000 IU/ml. The porcine pancreatic phospholipase utilized may be identified as lecitased 10L as supplied by Novo Nordisk;

Next the processed egg yolk material is incubated for 18 hours at a temperature of between 13.5 to 15° C. (56.3-59° F.) while maintaining a slow agitation;

Next, salt and corn syrup solids are added to obtain 3.51% salt and 1.87% corn syrup solids;

Next, the pH is checked and adjusted if necessary through the inclusion of a 10% solution of sodium bicarbonate to obtain a pH of between 6.0 and 6.2;

Next the processed egg yolk solution is homogenized at 150 bar (2,175 psi);

Next the homogenized processed liquid yolk material is pasteurized at 69° C. (154.4° F.) with a holding time of 12 to 15 minutes;

Finally, the pasteurized processed egg yolk material may be spray dried at 145° C. (293° F.) at the inlet, 65° C. (149° F.) at the outlet, where the spray dried powder is chilled to a temperature of between 25 to 30° C. (77-86° F.). In general, the EMY retort stable egg yolk powder includes a free flow agent of approximately 0.35% for inclusion within the final powder.

The retort stable egg yolk powder and/or liquid enzyme modified egg yolk product EMY is generally an egg product obtained from a process of catalytic hydrolysis of the free fatty acids from the phospholipid molecule. Processing conditions determine the degree of this hydrolysis and the subsequent functionality. The structural modification of the egg yolk does not change the appearance or nutritional profile for the product. The egg yolk may be blended with salt and/or corn syrup to compliment the enhanced functional properties.

EMY egg yolk is an excellent emulsifier that has been used in numerous food applications. EMY has superior emulsification properties as compared to standard egg yolk and is specifically intended for applications where heat addition of a 10% solution of sodium bicarbonate as required;

Next, the pH adjusted egg yolk material is slowly agitated whereupon porcine pancreatic phospholipase A2 is added to obtain approximately 68 milliliters of enzyme preparation having an activity of 10,000 IU/ml. The porcine pancreatic phospholipase utilized may be identified as lecitased 10L as supplied by Novo Nordisk;

Next the processed egg yolk material is incubated for 18 hours at a temperature of between 13.5 to 15° C. (56.3-59° F.) while maintaining a slow agitation;

Next, salt and corn syrup solids are added to obtain 3.5 1% salt and 1.87% corn syrup solids;

Next, the pH is checked and adjusted if necessary through the inclusion of a 10% solution of sodium bicarbonate to obtain a pH of between 6.0 and 6.2;

Next the processed egg yolk solution is homogenized at 150 bar (2,175 psi);

Next the homogenized processed liquid yolk material is pasteurized at 69° C. (154.4° F.) with a holding time of 12 to 15 minutes;

Finally, the pasteurized processed egg yolk material may be spray dried at 145° C. (293° F.) at the inlet, 65° C. (149° F.) at the outlet, where the spray dried powder is chilled to a temperature of between 25 to 30° C. (77-86° F.). In general, the EMY retort stable egg yolk powder includes a free flow agent of approximately 0.35% for inclusion within the final powder.

The retort stable egg yolk powder and/or liquid enzyme modified egg yolk product EMY is generally an egg product obtained from a process of catalytic hydrolysis of the free fatty acids from the phospholipid molecule. Processing conditions determine the degree of this hydrolysis and the subsequent functionality. The structural modification of the egg yolk does not change the appearance or nutritional profile for the product. The egg yolk may be blended with salt and/or corn syrup to compliment the enhanced functional properties.

EMY egg yolk is an excellent emulsifier that has been used in numerous food applications. EMY has superior emulsification properties as compared to standard egg yolk and is specifically intended for applications where heat stability of emulsions is desired.

EMY may be used in place of standard egg yolk providing similar results, and additionally provide heat stability for the final product. The emulsions formed using EMY tend to have greater viscosity and body as opposed to similar emulsions as formed from standard egg yolk. Typical emulsions when properly made with EMY may be heated by conventional, convection, steam, or microwave energy heat without emulsion failure. The heat stability provided by the EMY egg yolk allows for formulations of products to be retorted. The retorting of the final product provides enhanced flexibility in formulations to assist in insuring product quality and safety. EMY also confers freeze-thaw stability to emulsions. The stability of the EMY emulsions is dependent upon the properties of the particular oil utilized. The emulsion stability temperature is also directly proportional to the polyunsaturated fatty acids level in the oil.

The pasteurization/homogenization process for the forumlated traditional/classical Hollandaise Sauce extends for a sufficient period of time to kill pathogenic microorganisms such as bacteria. The time and temperature used for pasteurization/homogenization are inversely related. Thereby, when higher pasteurization/homogenization temperatures are utilized, pasteurization/homogenization may be conducted for shorter periods of time and conversely when lower pasteurization/homogenization temperatures are implemented, longer periods of time may be required to obtain adequate pasteurization/homogenization for the formulated traditional/classical Hollandaise Sauce. The preferred temperature for pasteurization is approximately 79.5° C.±2° C. or 175° F.±3° F. and the preferred pressure for homogenization is approximately 1500 psi.

The formulated traditional/classical Hollandaise Sauce following the completion of processing may be placed into containers through the use of conventional filling techniques and equipment. These filling techniques preferably involve the removal of undesirable air and the immediate sealing of the container. Filling may be performed under vacuum conditions with vacuum sealing of the final container or the filling techniques may be conducted using a stream of inert gas such as nitrogen to exclude oxygen from the final container. The placement of the formulated traditional/classical Hollandaise Sauce into sealed containers or packages provides an excellent food product having an improved life.

The present formulated traditional/classical Hollandaise Sauce is therefore superior to known Hollandaise Sauces by providing a substantially longer usable life and by enabling the sauce to be stored prior to use. The formulated traditional/classical Hollandaise Sauce does not require additional preserving agents such as potassium sorbate or sodium benzoate as are common in the art.

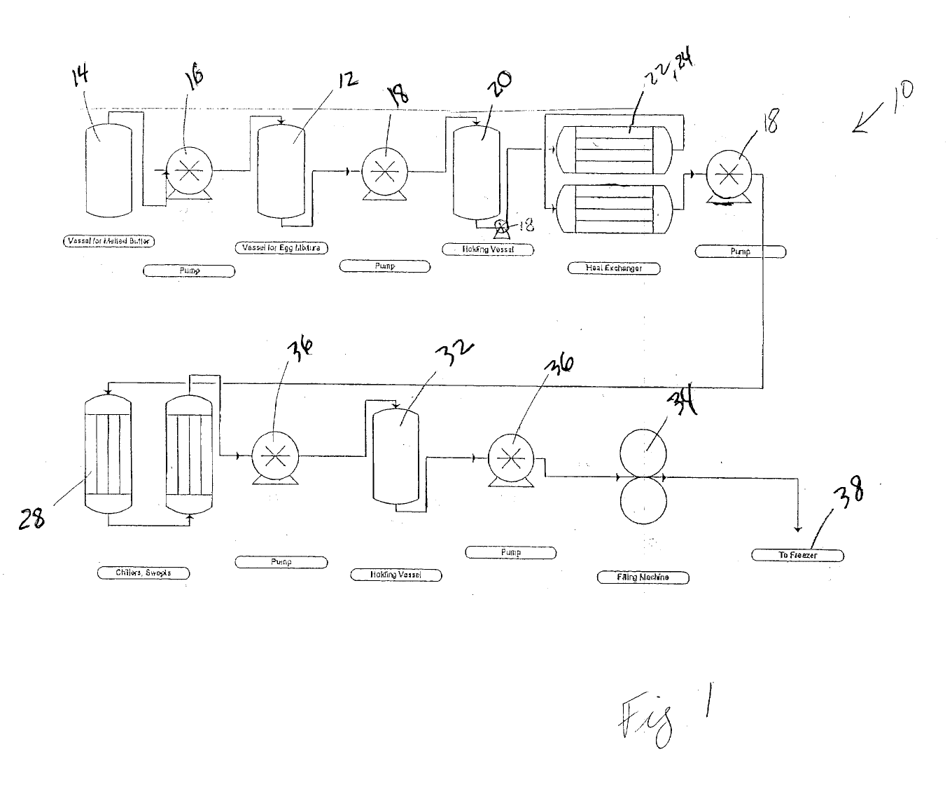

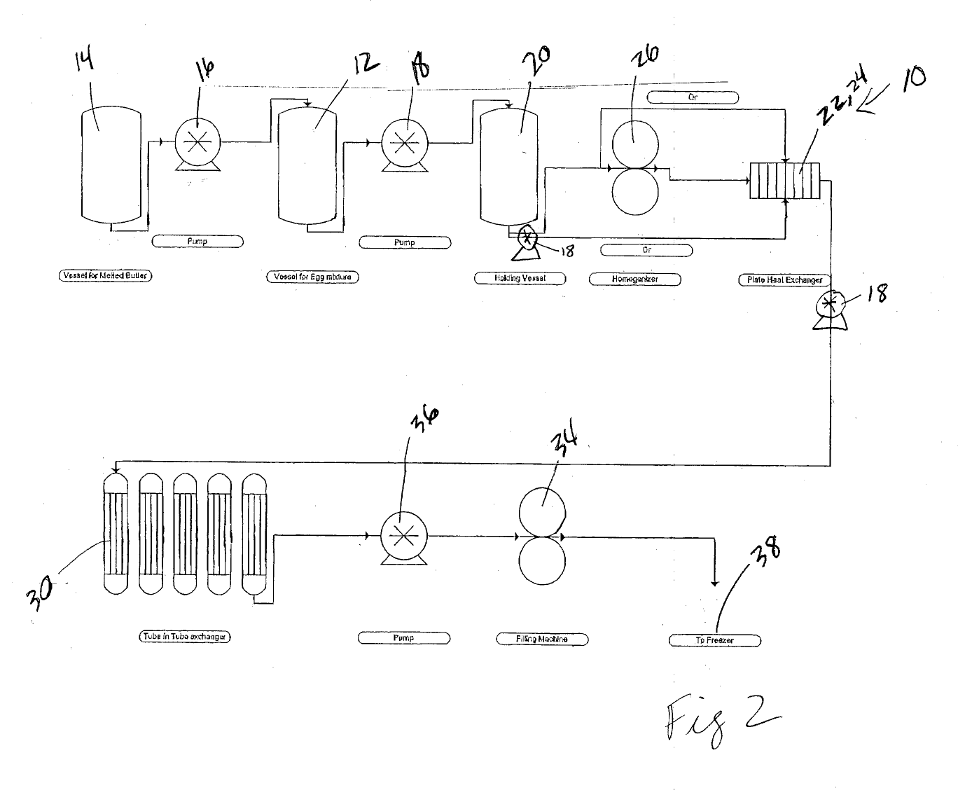

The steps for formation of the traditional/classical Hollandaise Sauce may be generally described as follows with reference to FIGS. 1 and 2. The process for formulation of the Hollandaise Sauce is generally referred to by the numeral 10.

As a preliminary processing step, the EMY egg yolk may be placed in a suitable container or vessel for processing pursuant to the method described herein.

The next step in manufacture of the formulated traditional/classical Hollandaise Sauce is to add the EMY egg yolk material to a previously mixed solution of water and citric acid for blending 12. The previously mixed solution may also include natural flavor.

The next step for the formulation of the traditional/classical Hollandaise Sauce is to melt butter to approximately 125° F. or 51.67° C. within a suitable vessel 14 while keeping the melted butter continuously agitated so that any butter solids remain in suspension.

The next step 16 for formulation of the traditional/classical Hollandaise Sauce is to slowly and gradually add a constant stream of melted butter into the whirling EMY egg yolk/water/citric acid solution. This may occur through the use of a pump 16. The melted butter may be added on a drop by drop basis initially and then at a very gradual increased rate to insure that an emulsion is formed. Following the addition of all the melted butter, the mixed butter/EMY egg yolk/water/citric acid solution should be mixed for an additional 60 seconds to insure the proper formation of an emulsified product.

In more detail, a suitable vessel 14 for holding the melted butter and/or melted margarine would be a steam jacketed kettle. Following complete melting of the butter and/or margarine, the melted butter and/or margarine may be pumped 16 to a second jacketed kettle 12 holding the previously mixed EMY egg yolk/water/citric acid mixture. The melted butter should remain in continuous motion to facilitate suspension of butter solids within the butter oil.

As earlier indicated, the EMY egg yolk/water/citric acid solution may be placed in a second jacketed kettle 12 where the EMY egg yolk is added to the mixed and previously dissolved citric acid and water solution. The EMY egg yolk/water/citric acid solution may be preheated or may remain cooled prior to combination with the melted butter or margarine. Generally, the EMY retort stable egg yolk is maintained at a temperature of 47° F. or 8.33° C. The EMY egg yolk/water/citric acid solution is also preferably in continuous motion to prevent settling and separation of the individual ingredients. The EMY retort stable egg yolk may be placed into a “Breddo-liquifier” where the dissolved solution of citric acid and water may be exposed to continuous agitation. Generally, the EMY retort stable egg yolk, citric acid, water, and natural flavor is mixed cold and has not been preheated prior to mixing with the melted butter ingredients. The EMY retort stable egg yolk may be salted in which case the butter and/or margarine as melted is unsalted. Alternatively, in the event that the EMY retort stable egg yolk is not salted, then the butter/margarine may be salted within the formulation of the Hollandaise Sauce.

Generally, the temperature of the now mixed and emulsified sauce (melted butter/EMY egg yolk/water/citric acid solution) is approximately 105° F. or 40.56° C. The pH, water activity, viscosity, and flavor of the formulated traditional/classical Hollandaise Sauce may then be tested. Generally, the traditional/classical Hollandaise Sauce is maintained in continuous motion to prevent breakdown of the formed emulsification. An Eisher mixer may be used to combine and mix the melted butter to the EMY egg yolk/water/citric acid solution as identified herein.

The next step 18 involves the transfer of the traditional/classical Hollandaise Sauce by a shear pump to a holding vessel 20 prior to transfer to a plate heater 22 and/or tube to tube heat exchanger 24 for initial pasteurization. Alternatively, the mixed Hollandaise Sauce may be transferred by a shear pump or centrifugal or positive displacement pump 18 to a homogenizer 26. It should be noted that the mixed Hollandaise Sauce may be initially pasteurized 22, 24 and then homogenized 26 or may be initially homogenized 26 and then pasteurized 22, 24 without affecting the quality of the formulated Hollandaise Sauce herein.

Generally, the temperature of the mixed traditional/classical Hollandaise Sauce immediately prior to transfer by the shear pump 18 to either the homogenizer 26 or pasteurizer 22, 24 is between 115° F. to 120° F. or 46.11° C. to 48.89° C. The mixed Hollandaise Sauce is preferably retained in this temperature range for approximately 22 seconds prior to exposure to the shear pump. The pH of the mixed liquid Hollandaise Sauce is approximately 4.7 to 4.8. Generally, the shear pump 18 includes as a component the smallest screen available for filtration and breakage of clumps within the Hollandaise Sauce.

Generally, homogenization 26 may be provided in two stages where the first stage exposes the mixed liquid Hollandaise Sauce to 500 psi and the second stage exposes the mixed liquid Hollandaise Sauce to 1000 psi. Generally, the mixed liquid Hollandaise Sauce is homogenized for approximately 30 seconds±5 seconds.

The next step for formulation of the traditional/classical Hollandaise Sauce may be the transfer 18 of the homogenized Hollandaise Sauce for pasteurization at a heat exchanger 22, 24.

Pasteurization may occur through the use of a plated heat exchanger 22 set for a temperature of 175° F.±3° F. or 79.44° C.±2° C. Generally the homogenized mixed liquid Hollandaise Sauce is exposed to pasteurization for approximately 25 to 30 seconds. The heat exchanger 22 as described herein may alternatively be a swept surface heat exchanger which may provide counter agitation to the homogenized mixed liquid Hollandaise Sauce.

Generally, the heat exchanger is preheated to a temperature of approximately 140° F. to 150° F. or 60° C. to 65.56° C. Alternatively, the heat exchanger may be a tube to tube heat exchanger 24 for exposure of the mixed liquid Hollandaise Sauce to temperatures approximating 175° F. or 79.5° C. for a period of time of approximately 25 to 30 seconds.

Generally, the heat as generated within the heat exchanger and exposed to the mixed liquid Hollandaise Sauce changes the emulsion for creation of a protein gel. Heat changes the emulsion of the liquid Hollandaise Sauce from an emulsified product to a protein gel product. The transition of an emulsified Hollandaise Sauce to a protein gel followed by the destruction of the gel to provide the traditional/classical Hollandaise Sauce is unique within the industry.

The next step for formulation of the traditional/classical Hollandaise Sauce is the transport of the previously homogenized and pasteurized sauce for cooling at a swept surface heat exchanger 28 or tube in tube heat exchanger 30, which reduces the temperature to approximately 110° F. or 43.33° C. Alternatively, the cooling element may be a plate chiller which reduces the temperature of the homogenized and pasteurized liquid Hollandaise Sauce to between 105° F. and 110° F. or 38.4° C. and 43.33° C. The cooled Hollandaise Sauce may then be transferred 18 to a sterile hopper 32 for holding for a desired period of time. The Hollandaise Sauce is required to remain liquefied and may not gel following cooking as long as temperatures are above 100° F., it becomes to viscous to pump. Alternatively, the homogenized and pasteurized Hollandaise Sauce may be exposed to a chill press having an exit temperature of approximately 105° F.±3° F. or 38.4° C.

The chilling process of the previously homogenized and pasteurized Hollandaise Sauce breaks the protein gel structure through the chilling press to produce a pourable sauce. The breaking of the protein gel structure permits the Hollandaise Sauce to be reheated without risk of separation or breaking into water and oil phases. Alternatively, the cooling of the previously homogenized and pasteurized liquid Hollandaise Sauce may occur within a two stage homogenizer which is valve cooled with glycol. The cooled Hollandaise Sauce may then be transferred into a filling chamber 34 for processing into individual packages.

Following cooling of the previously pasteurized and homogenized Hollandaise Sauce, the Hollandaise Sauce is passed through a second shear pump 36, centrifugal pump, and/or positive displacement pump to assist in the breaking of the protein gel structure prior to packaging. The forces of the shear pump, positive displacement pump, and/or centrifugal pump 36 assist in liquefying the Hollandaise Sauce for deposit into a sterilized hopper 32 which in turn is in communication with individual packaging equipment.

The next step for formulation of the Hollandaise Sauce is to individually package the sauce into three ounce flexible packages having dimensions approximating 3 inches by 5 inches. The temperature during the filling procedure is approximately 105° F. or 40.56° C. A pouch creator may be in communication with the packaging equipment to assist in the packaging of the processed Hollandaise Sauce.

It is anticipated that the formulated traditional/classical Hollandaise Sauce will be aseptically packaged for elimination of undesirable microbes and bacteria. A high degree of security is thereby provided that no mold or bacterial agents are available within the package to contaminate the product. Within a continuously sterilized zone, the cooled Hollandaise Sauce may be filled into sterile packaging materials such as totes, pouches, bags, or other packaging containers where capping and sealing may occur.

Alternatively the formulated traditional/classical Hollandaise Sauce having extended life under ambient conditions may be packaged within Scholle bags or any other type of desired package for heating by placement of the package into boiling water, by opening for microwave heating, or by opening for placement of the Hollandaise Sauce within a container for heating upon a stove surface.

A conveyor may transport the packaged Hollandaise Sauce to a Spiral freezer 38 for storage. Alternatively, a conveyor may transport the packaged Hollandaise Sauce to a refrigerator.

A unique feature of the invention is that the enzyme modified egg yolk forms a protein gel with lipids, “a gel” where the proteins and the lipids remain together in an emulsified macromolecular state.

The gel needs a finishing step to break the gel into tiny fragments to become, or return to, a liquefied and pourable state. In this procedure, the gel does not return to an emulsification upon reheating.

In the past, reheating of an emulsion was unavailable because exposure of the emulsion to heat caused the viscosity to decrease which would lead to flocculation then coalescence and then to phase separation.

By changing the physical properties of the Hollandaise Sauce as described by the procedures herein, the phase separation of oil and water may be avoided.

The heating and holding process described herein may be accomplished using any of several continuous flow pasteurization systems, tank or vat pasteurization systems, and/or by filling the pre-heated liquid mixture into various packages and holding the sealed containers for predetermined periods of time in an insulated and/or heated chamber (hot-fill and hold pasteurization processing techniques).

In a first embodiment, the formulated traditional/classical Hollandaise Sauce is formed of EMY processed egg yolk in an amount typically between 13% and 16% by weight of the final mixture. To the processed EMY egg yolk, melted butter is added in an amount of typically between 73% and 77% by weight of the final mixture. In addition, citric acid is added in an amount typically between 0.04% and 0.15% by weight for blending with water and the processed EMY egg yolk material. Water is also added to the liquid Hollandaise Sauce where water forms approximately 8.75% to 9.75% by weight of the Hollandaise Sauce. The Hollandaise Sauce may also include natural flavor in an amount of approximately 0.05% to 0.30% of the weight of the final product.

A variation of this embodiment would include the utilization of melted margarine in substitution for the melted butter in an approximate amount of between 73% and 77% by weight of the Hollandaise Sauce.

A first example of the formulated traditional/classical Hollandaise Sauce would include the use of EMY retort stable egg yolk having a percentage weight of 14.36% (salted), butter having a percentage weight of 76.26% (unsalted), citric acid having a percentage weight of 0.06%, and water having a percentage weight of 9.33% where the combination of these ingredients pursuant to the method of process described herein would yield a Hollandaise Sauce which may be cooled and/or frozen for reheating at a future time without separation of the oil and water phases for use with a consumable food article.

A second example of the formulated traditional/classical Hollandaise Sauce would include the use of EMY retort stable egg yolk (salted) having a percentage weight of 15.56%, butter (unsalted) having a percentage weight of 74.81%, citric acid having a percentage weight of 0.1%, and water having a percentage weight of 9.28%, and natural flavor having a percentage weight of 0.25% where the combination of these ingredients pursuant to the method of process described herein would yield a Hollandaise Sauce which may be cooled and/or frozen for reheating at a future time without separation of the oil and water phases for use with a consumable food article.

A third example of the formulated traditional/classical Hollandaise Sauce would include the use of EMY retort stable egg yolk (salted) having a percentage weight of 15.59%, margarine (unsalted) having a percentage weight of 74.94%, citric acid having a percentage weight of 0.1%, and water having a percentage weight of 9.29%, and natural flavor having a percentage weight of 0.08% where the combination of these ingredients pursuant to the method of process described herein would yield a Hollandaise Sauce which may be cooled and/or frozen for reheating at a future time without separation of the oil and water phases for use with a consumable food article.

A fourth example of the formulated traditional/classical Hollandaise Sauce would include the use of EMY retort stable egg yolk (salted) having a percentage weight of 15.57%, butter (unsalted) having a percentage weight of 74.85%, citric acid having a percentage weight of 0.1%, and water having a percentage weight of 9.28%, and natural flavor having a percentage weight of 0.2% where the combination of these ingredients pursuant to the method of process described herein would yield a Hollandaise Sauce which may be cooled and/or frozen for reheating at a future time without separation of the oil and water phases for use with a consumable food article.

A fifth example of a formulated traditional/classical Hollandaise Sauce would include the use of EMY retort stable egg yolk (salted) having a percentage weight of 14.44%, butter (unsalted) having a percentage weight of 76%, citric acid having a percentage weight of 0.06%, and water having a percentage weight of 9.5%, where the combination of these ingredients pursuant to the method of process described herein would yield a Hollandaise Sauce which may be cooled and/or frozen for reheating at a future time without separation of the oil and water phases for use with a consumable food article.

### EXAMPLE A

In one example 762.6 lbs. or 345.91 kgs. of unmelted butter was placed into a steam jacket kettle or mixing vat and then exposed to a temperature of approximately 125° F. or 51.67° C. Heat was continued for a period of time sufficient to melt all the butter. During the melting process, the butter was continuously agitated to insure suspension of the butter solids.

To a second steam jacket kettle or mixing vat, 93.3 lbs. or 42.32 kgs. of water was added. Citric acid in the amount of 0.6 lbs. or 272.16 gs. was then added to the water where mixing was initiated through the use of and admix high shear mixer for a sufficient period of time (approximately one minute) at high speed to result in a homogeneous solution of citric acid/water mixture.

Next, 143.6 lbs. or 65.14 kgs. of EMY retort stable egg yolk were then added to the stem jacket kettle or mixing vat containing the citric acid/water mixture. Mixing then continued at high rpm for sufficient duration of time (approximately one minute) to result in a homogeneous mixture.

The melted butter was then poured into the mixing vat containing the EMY citric acid, water solution. The melted butter was initially drizzled by deposit of a slow stream and then the amount of butter added was gradually increased to a steady stream which was combined with the EMY, citric acid, water solution to form an emulsion. Mixing continued for a period of time of approximately 60 seconds following the complete addition of all of the melted butter within the mixing vat.

A shear pump having the smallest available screen then pumped the blended butter, EMY, citric acid, water solution while agitation continued to a homogenizer. The temperature of the liquid mixture was retained at approximately 115° F. or 46.11° C. to 120° F. or 48.89° C. The hold time at the shear pump was approximately 22 seconds.

The homogenizer operated in two stages where a first stage exposed the blended/mixed Hollandaise Sauce solution to a pressure of 500 psi for a first duration of time and then at a second stage exposed the mixed/blended Hollandaise Sauce to a pressure of 1000 psi.

The mixed liquid Hollandaise Sauce was then transferred for pasteurizing at a heat exchanger. The heat exchanger was preferably preheated to a temperature of between 140° F. or 60° C. to 150° F. or 65.56° C. The liquid mixed Hollandaise Sauce was then pasteurized by exposure to heat of approximately 175° F.±3° C. or 79.5° C. for a hold time of approximately 25 to 30 seconds. The heat exposed to the mixed liquid Hollandaise Sauce initiated the breakdown of the emulsion into a protein gel. The heating of the mixed liquid Hollandaise Sauce changes the previously formed emulsion from an emulsified product to a protein gel product.

The heat exchanger used for pasteurization was a plate heat exchanger, however, a swept surface heat exchanger such as a Contherm swept surface heat exchanger which includes counter agitation; a tube and tube heat exchanger (Feldmeier system); a scraped surface heat exchanger; and/or a steam heat exchanger may be utilized in the pasteurization process. It should be noted that more than one type of heat exchanger may be used in the pasteurization process.

The pasteurized Hollandaise Sauce was then transferred/pumped to a sterile containment vessel or hold kettle utilizing a swept surface heat exchanger to initiate cooling. The swept surface heat exchanger reduced the temperature of the pasteurized Hollandaise Sauce toward the temperature goal of approximately 110° F. or 43.33° C. Additional cooling of the pasteurized Hollandaise Sauce was accomplished by the use of a chilled plate heat exchanger where additional cooling continued for a duration of time of approximately 33 seconds, in conjunction with a chill press, which reduced the temperature of the Hollandaise Sauce to approximately 105° F. or 40.56° C. The chilling by plate of the Hollandaise Sauce breaks the protein gel causing the liquefication of the product.

Following cooling, the Hollandaise Sauce was transferred by a shear, positive displacement or centrifugal pump having the smallest available screen to assist in the breaking of the protein gel and liquefication of the Hollandaise Sauce for transfer to a sterilized hopper integral to a depositor.

The depositor was in communication with package equipment which utilized a nitrogen gas flush to eliminate air within the head space of a flexible package containing approximately 3 ounces of Hollandaise Sauce. Each flexible package contained dimensions of approximately 3 inches by 5 inches. The temperature of the Hollandaise Sauce at the time of packaging was approximately 100° F. or 37.78° C. The packaged Hollandaise Sauce was then transferred to a Spiral freezer by a conveyor for freezing. Three packages of frozen Hollandaise Sauce were then retrieved from the freezer and reheated using boiling water, where the frozen package was placed within the boiling water, a stove top heating where the package was thawed, opened, and then placed within a sauce pan for heating, and a third heating application which utilized the thawing and opening of the package and placement of the contents into a suitable microwave container for heating within a microwave oven. In all three applications, an acceptable Hollandaise Sauce was provided for use in conjunction with consumable food article.

### EXAMPLE B

The EMY egg yolk was derived according to the procedures identified herein.

For this example, 748.1 lbs or 339.33 kgs. of unmelted butter was placed into a steam jacket kettle or mix tank and exposed to a temperature of approximately 125° F. or 51.67° C. Heat was continued for a period of time sufficient to melt all the butter. During the melting process, the butter was continuously agitated to insure suspension of the butter solids.

To a second steam jacket kettle or mixing vat, 92.8 lbs. or 42.09 kgs. of water was added. Citric acid in the amount of 1 lb. or 0.45 kgs. was added to the water. In addition, 2.5 lbs. or 1.13 kgs. of natural flavor were added to the water where mixing was initiated through the use of an admix high shear mixer for a sufficient period of time of approximately 1 minute at high speed to result in a homogeneous liquid citric acid, water, natural egg flavor mixture.

Next, 155.6 lbs. or 70.58 kgs of EMY retort stable egg yolk were added to the steam jacket kettle/mixing vat holding the citric acid, water, natural flavor solution, where mixing continued at a high speed for a sufficient duration of time (approximately 1-2 minutes) to result in a homogeneous mixture.

The remaining process procedures as identified within Example A were repeated herein which yielded a reheatable Hollandaise Sauce for use with a consumable food article.

### EXAMPLE C

The EMY egg yolk was derived according to the procedures identified herein.

In this example, 749.4 lbs or 339.92 kgs. of margarine was placed into a steam jacket kettle or mix tank and then exposed to a temperature of approximately 125° F. or 51.67° C. Heat was continued for a period of time sufficient to melt all the margarine. During the melting process, the margarine was continuously agitated to insure suspension of the solids.

To a second steam jacket kettle or mixing vat, 92.9 lbs. or 42.14 kgs. of water was added. Citric acid in the amount of 1 lb. or 0.45 kgs. was added to the water in addition to 0.8 lbs. or 0.36 kgs. of natural flavor whereupon mixing was initiated through the use of an admix high shear mixer for a sufficient period of time (approximately 1 minute) at high speed to result in a homogeneous liquid citric acid, water, natural egg flavor mixture.

Approximately 155.9 lbs. or 70.71 kgs. of EMY retort stable egg yolk were then added to the steam jacket kettle/mixing vat holding the citric acid, water, natural flavor mixture. Mixing continued at high speed for a sufficient duration of time (approximately 1-2 minutes) to result in a homogeneous mixture.

The remaining process procedures as identified within Example A were repeated herein which yielded a reheatable Hollandaise Sauce for use with a consumable food article.

### EXAMPLE D

The EMY egg yolk was derived according to the procedures identified herein.

In this example, 748.5 lbs or 339.51 kgs. of unmelted butter was placed into a steam jacket kettle or mix tank and then exposed to a temperature of approximately 125° F. or 51.67° C. Heat was continued for a period of time sufficient to melt all the butter. During the melting process, the butter was continuously agitated to insure suspension of the butter solids.

To a second steam jacket kettle or mixing vat, 92.8 lbs. or 42.09 kgs. of water was added. Citric acid in the amount of 1 lb. or 0.45 kgs. was added to the water in conjunction with 2 lbs. or 0.91 kgs. of natural flavor were mixing was initiated through the use of an admix high shear mixer for a sufficient duration of time of (approximately 1 minute) at high speed to result in a homogeneous mixture.

Next, 155.7 lbs. or 70.62 kgs. of EMY retort stable egg yolk were added to the steam jacket kettle/mixing vat holding the citric acid, natural flavor, water mixture, where mixing continued at high speed for a sufficient duration of time of approximately 1-2 minutes to result in a homogeneous mixture.

The remaining process procedures as identified within Example A were repeated herein which yielded a reheatable Hollandaise Sauce for use with a consumable food article.

### EXAMPLE E

The EMY egg yolk was derived according to the procedures identified herein.

In this example, 760.0 lbs or 344.73 kgs. of unmelted butter was placed into a steam jacket kettle or mix tank and then exposed to a temperature of approximately 125° F. or 51.67° C. Heat was continued for a period of time sufficient to melt all of the butter. During the melting process, the butter was continuously agitated to insure suspension of the butter solids.

To a second steam jacket kettle or mixing vat, 95.0 lbs. or 43.09 kgs. of water was added. Citric acid in the amount of 0.6 lb. or 272.16 gs. was added to the water where mixing was initiated through the use of an admix high shear mixer for a sufficient period of time of (approximately 1 minute) at high speed to result in a homogeneous liquid citric acid, water mixture.

Next, 144.4 lbs. or 65.5 kgs. of EMY retort stable egg yolk were added to the steam jacket kettle/mixing vat holding the citric acid, water mixture, where mixing continued at high speed for a sufficient duration of time (approximately 1-2 minutes) to result in a homogeneous mixture.

The remaining processing procedures as identified within Example A were repeated herein which yielded a reheatable Hollandaise Sauce for use with a consumable food article.

### EXAMPLE F

The EMY egg yolk was derived according to the procedures identified herein.

In this example, 746.1 lbs or 338.43 kgs. of unmelted butter was placed into a steam jacket kettle or mix tank and then exposed to a temperature of approximately 125° F. or 51.67° C. Heat was continued for a period of time sufficient to melt all the butter. During the melting process, the butter was continuously agitated to insure suspension of the butter solids.

To a second steam jacket kettle or mixing vat, 92.8 lbs. or 42.09 kgs. of water was added. Citric acid in the amount of 1.2 lb. or 0.54 kgs. in conjunction with 0.8 lbs. or 0.36 kgs. of natural flavor and 1 lb. or 0.45 kgs. of lemon juice were added to the water where mixing was initiated through the use of an admix high shear mixer for a sufficient period of time (approximately 1 minute) at high speed to result in a homogeneous liquefied citric acid, water, natural flavor, lemon juice mixture.

Next, 158.1 lbs. or 71.71 kgs. of EMY retort stable egg yolk were added to the steam jacket kettle/mixing vat holding the citric acid, natural flavor, lemon juice, water mixture, where mixing continued at a high speed for a sufficient duration of time (approximately 1-2 minutes) to result in a homogeneous mixture.

The remaining process procedures as identified within Example A were repeated herein which yielded a reheatable Hollandaise Sauce for use with a consumable food article.

### EXAMPLE G

The EMY egg yolk was derived according to the procedures identified herein.

In this example, 750.7 lbs or 340.51 kgs. of unmelted butter margarine blend was placed into a steam jacket kettle or mix tank and then exposed to a temperature of approximately 125° F. or 51.67° C. Heat was continued for a period of time sufficient to melt all of the butter margarine blend. During the melting process, the butter margarine blend was continuously agitated to insure suspension of the solids.

To a second steam jacket kettle or mixing vat, 92.6 lbs. or 42 kgs. of water was added. Citric acid in the amount of 0.7 lbs. or 0.32 kgs. in conjunction with 1 lb. or 0.45 kgs. of natural flavor were added to the water were mixing was initiated through the use of an admix high shear mixer for a suitable period of time (approximately 1 minute) at high speed to result in a homogeneous liquefied citric acid, natural flavor, water mixture.

Next, 156 lbs. or 70.76 kgs. of EMY retort stable egg yolk were added to the steam jacket kettle/mixing vat holding the citric acid, natural flavor, water mixture, where mixing continued at a speed of approximately 3450 rpm for a sufficient duration of time (approximately 1-2 minutes) to result in a homogeneous mixture.

The remaining processing procedures as identified within Example A were repeated herein which yielded a reheatable Hollandaise Sauce for use with a consumable food article.

### EXAMPLE H

The EMY egg yolk was derived according to the procedures identified herein.

In this example, 750.7 lbs or 340.51 kgs. of unsalted unmelted butter was placed into a steam jacket kettle or mix tank and then exposed to a temperature of approximately 125° F. or 51.67° C. Heat was continued for a period of time sufficient to melt all of the unsalted butter. During the melting process, the unsalted butter was continuously agitated to insure suspension of the butter solids.

To a second steam jacket kettle or mixing vat, 92.6 lbs. or 42.0 kgs. of water was added. Citric acid in the amount of 0.7 lbs. or 0.32 kgs. was added to the water where mixing was initiated through the use of an admix high shear mixer for a suitable duration of time (approximately 1 minute) at high speed to result in a homogeneous liquefied citric acid, water mixture.

Next, 156 lbs. or 70.76 kgs. of EMY retort stable egg yolk were added to the steam jacket kettle/mixing vat holding the citric acid, water mixture, where mixing continued at high speed for a sufficient duration of time (approximately 1-2 minutes) to result in a homogeneous mixture.

The remaining processing procedures as identified within Example A were repeated herein which yielded a reheatable Hollandaise Sauce for use with a consumable food article.

### EXAMPLE I

The EMY egg yolk was derived according to the procedures identified herein.

In this example, 750.7 lbs or 340.51 kgs. of unmelted sweet gold margarine was placed into a steam jacket kettle or mix tank and then exposed to a temperature of approximately 125° F. or 51.67° C. Heat was continued for a period of time sufficient to melt all the margarine. During the melting process, the margarine was continuously agitated to insure suspension of the solids.

To a second steam jacket kettle or mixing vat, 92.6 lbs. or 42.0 kgs. of water was added. Citric acid in the amount of 0.7 lbs. or 0.32 kgs. was added to the water were mixing was initiated through the use of an admix high shear mixer for a suitable period of time (approximately 1 minute) at high speed to result in a homogeneous liquefied citric acid, water mixture.

Next, 156 lbs. or 70.76 kgs. of EMY retort stable egg yolk were added to the steam jacket kettle/mixing vat holding the citric acid, water mixture, where mixing continued at high speed for a sufficient duration of time (approximately 1-2 minutes) to result in a homogeneous mixture.

The remaining process procedures as identified within Example A were repeated herein which yielded a reheatable Hollandaise Sauce for use with a consumable food article.

### EXAMPLE J

The EMY egg yolk was derived according to the procedures identified herein.

In this example, 760 lbs or 344.73 kgs. of unmelted butter was placed into a steam jacket kettle or mix tank and then exposed to a temperature of approximately 125° F. or 51.67° C. Heat was continued for a period of time sufficient to melt all the butter. During the melting process, the butter was continuously agitated to insure suspension of the butter solids.

To a second steam jacket kettle or mixing vat, 99.5 lbs. or 45.13 kgs. of water was added. Citric acid in the amount of 0.6 lbs. or 272.16 gs. was added to the water were mixing was initiated through the use of an admix high shear mixer for a sufficient duration of time (approximately 1 minute) at high speed to result in a homogeneous liquid citric acid, water mixture.

Next, 144.4 lbs. or 65.5 kgs. of EMY retort stable egg yolk were added to the steam jacket kettle/mixing vat holding the citric acid, water mixture, where mixing continued at high speed for a sufficient duration of time (approximately 1-2 minutes) to result in a homogeneous mixture.

The remaining processing procedures as identified within Example A were repeated herein which yielded a reheatable Hollandaise Sauce for use with a consumable food article.

As described herein, the heating and holding process for pasteurization may be accomplished using any of several continuous flow pasteurization systems, tank or vat pasteurization systems as are known in the art.

The shear pump as described herein may be suitably replaced with a positive displacement pump and/or a centrifugal pump, which may have specifications of 432 feet of 3 inch diameter holding tubes. The flow rate of Hollandaise Sauce through the positive displacement pump may occur at a rate regulated for 230 lbs. passage per minute. Alternatively, the shear pumps as described herein may be replaced by centrifugal pumps as are known in the art.

The admix shear mixer as described herein may be suitably replaced with a Krämer and Greby multi-mix mixer or a Hobart blender at the discretion of an individual.

Reheating of previously cooled and/or frozen Hollandaise Sauce may occur through a continuous forced draft convection heating oven as available from Wolverine Proctor. Other types of stoves and/or ovens may be used to accommodate reheating of previously cooled or frozen Hollandaise Sauce at the discretion of an individual.

The freezing of packages of Hollandaise Sauce may occur alternatively by exposure to carbon dioxide snow, cryogenic liquid nitrogen, placement within a carbon dioxide freezing tunnel, and/or through conventional freezing techniques.

It should be noted that the methodology described herein identifies the homogenizing process occurring before the pasteurization process. It should be noted that the order of the homogenizing step and/or pasteurization step are interchangeable and may occur in any order as desired during the formulation of the Hollandaise Sauce as described herein.

The disclosed formulation for the Hollandaise Sauce and process to prepare the formulated traditional/classical Hollandaise Sauce originates with EMY egg yolk and melted butter which, combined with other ingredients and heat treated, may be frozen and/or refrigerated for reheating within microwave ovens, convection ovens, griddles or any other type of heating device without limitation, for consumption as a component of a consumable food product. The formulated traditional/classical Hollandaise Sauce may include a wide range of egg product and ingredient formulations, which when mixed, frozen and/or refrigerated, followed by reheating result in a visually and sensory appealing formulated traditional/classical Hollandaise Sauce.

Ordinarily one would not expect the control of ingredients, the regulation of temperature, the control of cooking conditions, and the management of mixing parameters during food processing to yield an enhanced formulated traditional/classical Hollandaise Sauce. The failure to control ingredients, regulate the temperature of the conditions during cooking, and/or the management of mixing parameters may significantly degrade the integrity of sensory and taste perceptions for the traditional/classical Hollandaise Sauce. Control of ingredients, regulation of the temperature during cooking conditions, and management of mixing parameters provides enhanced consistency and integrity for the formulated traditional/classical Hollandaise Sauce and enables the Hollandaise Sauce to remain intact through processing, freezing or refrigeration, and subsequent reheating prior to consumption by an individual.

The formulations and food process techniques described herein further minimize waste of the consumable formulated traditional/classical Hollandaise Sauce.

Generally the mixing time for the respective components of the Hollandaise Sauce is to be minimized and generally is no longer than necessary to insure adequate mixing.

The individual packages of formulated traditional/classical Hollandaise Sauce may be individually quick frozen. Individual quick freezing of the packages of Hollandaise Sauce should occur in a short duration of time. Generally as the time required for freezing decreases the quality of the frozen article after thawing increases. A Spiral freezer may be utilized to individually quick freeze the packages of formulated traditional/classical Hollandaise Sauce. The through-put for the freezer may establish a freezing time of approximately 30 minutes. The formulated traditional/classical Hollandaise Sauce may be exposed to a temperature below −10° F., −23.33° C. and not to exceed 20° F., −6.67° C. Individual quick freezing of the pasteurized and formulated traditional/classical Hollandaise Sauce provides safety advantages minimizing food related health and/or contamination issues. Following the individual quick freezing of the cooked formulated traditional/classical Hollandaise Sauce, the packages of the Hollandaise Sauce may endure being frozen, refrigerated, and/or being kept hot prior to consumption by an individual as a portion of a food item without the sacrifice of product quality.

The ingredients described herein have been provided for illustrative purposes only and the group of ingredients identified herein may comprise any number of additional items identified in this description or which have not been previously identified.

It should be noted that the process steps identified above may be substantially interchained and modified without sacrifice as to the final formulated Hollandaise Sauce so long as the ingredients, temperature, and mixing time are regulated.

In general, the ingredients identified herein have been provided for illustrative purposes and should not be considered as restrictive

It should be noted that the percentage weights provided herein have been rounded mathematically which in certain instances may not exactly equal 100%. In these instances, the percentage of EMY egg yolk, butter, and/or water may be insignificantly increased or decreased to provide a 100% summation.

The above examples and disclosure are intended to be illustrative and not exhaustive. These examples and description will suggest many variations and alternatives to one of ordinary skill in the art. All of these alternatives and variations are intended to be included within the scope of the attached claims. Those familiar with the art may recognize other equivalents to the specific embodiments described herein which equivalents are also intended to be encompassed by the claims attached hereto.

The present invention may be embodied in other specific forms without departing from the spirit or essential attributes thereof, therefore; the illustrative embodiments should be considered in all respects as illustrative and not restrictive, reference being made to dependent claims rather than to the foregoing description to indicate the scope of the invention.

While this invention may be embodied in many different forms, there are described in detail herein specific preferred embodiments of the invention. This description is an exemplification of the principles of the invention and is not intended to limit the invention to the particular embodiments illustrated.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below (e.g. claim 3 may be taken as alternatively dependent from claim 2; claim 4 may be taken as alternatively dependent on claim 2, or on claim 3; claim 6 may be taken as alternatively dependent from claim 5; etc.).

This completes the description of the preferred and alternate embodiments of the invention. Those skilled in the art may recognize other equivalents to the specific embodiment described herein which equivalents are intended to be encompassed by the claims attached hereto.

I claim:

1. A consumable Hollandaise Sauce comprising:
a) enzyme modified egg yolk, wherein said enzyme modified egg yolk forms between 13% and 22.5% by weight of said Hollandaise Sauce;
b) butter wherein said butter forms between 62.5% and 77% by weight of said Hollandaise Sauce;
c) citric acid wherein said citric acid forms between 0.05% and 0.15% by weight of said Hollandaise Sauce; and
d) water wherein said water forms between 2.0% and 10% by weight of said Hollandaise Sauce where in the amount of said enzyme modified egg yolk, said butter, said citric acid, and said water when combined equals 100% of said Hollandaise Sauce.

2. The Hollandaise Sauce according to claim 1, said Hollandaise Sauce further comprising natural flavor, said natural flavor forming between 0.07% and 1.0% by weight of said Hollandaise Sauce wherein the amount of said enzyme modified egg yolk, said butter, said citric acid, said water, and said natural flavor when combined equals 100% of said Hollandaise Sauce.

3. The Hollandaise Sauce according to claim 1, wherein said Hollandaise Sauce is formed according to the process comprising:
a) acquisition of enzyme modified egg yolk;
b) melting said butter within a first vessel;
c) mixing said enzyme modified egg yolk, said water, and said citric acid in a second vessel;
d) combining said melted butter to said second vessel to form an emulsion;
e) transferring said emulsion to a homogenizer and homogenizing said emulsion;
f) transferring said homogenized emulsion to a heat exchanger for pasteurization and conversion of said emulsion into a protein gel;
g) transferring said protein gel to a cooling device; and
h) cooling said protein gel initiating liquefication of said Hollandaise Sauce.

4. The Hollandaise Sauce according to claim 3, further comprising cooling of said liquefied Hollandaise Sauce.

5. The Hollandaise Sauce according to claim 4, further comprising packaging of said liquefied Hollandaise Sauce and freezing said packaged liquid Hollandaise Sauce.

6. The Hollandaise Sauce according to claim 5, further comprising thawing and reheating said frozen Hollandaise Sauce.

7. The Hollandaise Sauce according to claim 3, said transferring said emulsion to said homogenizer comprising use of a shear pump.

8. The method according to claim 5, further comprising transferring said Hollandaise Sauce to a depositor prior to said packaging.

9. The method according to claim 8, said transferring said Hollandaise Sauce to said depositor comprising use of a shear pump.

10. The Hollandaise Sauce according to claim 3, said pasteurizing comprising exposure of said emulsion to a temperature of between 165° F. and 185° F.

11. The Hollandaise Sauce according to claim 1, further comprising replacement of said butter with margarine.

12. The Hollandaise Sauce according to claim 1, further comprising replacement of said butter with a butter margarine blend.

13. The Hollandaise Sauce according to claim 3, further comprising replacement of said butter with margarine.

14. The Hollandaise Sauce according to claim 13, said transferring said emulsion to said homogenizer comprising the use of a shear pump.

15. The Hollandaise Sauce according to claim 13, further comprising packaging said cooled liquefied Hollandaise Sauce.

16. The Hollandaise Sauce according to claim 15, further comprising transferring said cooled Hollandaise Sauce to a depositor prior to said packaging.

17. The Hollandaise Sauce according to claim 16, said transferring said cooled Hollandaise Sauce to said depositor comprising use of a shear pump.

18. The Hollandaise Sauce according to claim 3, further comprising replacement of said butter with a butter margarine blend.

19. The Hollandaise Sauce according to claim 18, said transferring said emulsion to said homogenizer comprising use of a shear pump.

20. The Hollandaise Sauce according to claim 18, further comprising packaging said liquefied Hollandaise Sauce.

21. The Hollandaise Sauce according to claim 20 further comprising transferring said Hollandaise Sauce to a depositor prior to said packaging.

22. The Hollandaise Sauce according to claim 21, said transferring said Hollandaise Sauce to said depositor comprising use of a shear pump.

23. A process for formation of a Hollandaise Sauce comprising:
a) acquisition of enzyme modified egg yolk;
b) acquisition of butter and melting of said butter within a first vessel;
c) acquisition of water and citric acid and mixing said enzyme modified egg yolk, said water, and said citric acid into a second vessel;
d) combining said melted butter to said second vessel to form an emulsion;
e) transferring said emulsion to a homogenizer and homogenizing said emulsion;
f) transferring said homogenized emulsion to a heat exchanger for pasteurization and conversion of said emulsion to a protein gel;
g) transferring said protein gel to a cooling device; and
h) cooling said protein gel initiating liquefication of said Hollandaise Sauce.

24. The process according to claim 23 further comprising packaging said cooled liquefied Hollandaise Sauce.

25. The process according to claim 23 said transferring said emulsion to said homogenizer comprising use of a shear pump.

26. The process according to claim 24 further comprising transferring said cooled Hollandaise Sauce to a depositor prior to said packaging.

27. The process according to claim 26 said transferring of said cooled Hollandaise Sauce to said depositor comprising use of a shear pump.
